(19) United States
(12) Patent Application Publication
(10) Pub. No.: US 2010/0327224 A1
(43) Pub. Date: Dec. 30, 2010

(54) Compounds for Desulfurization of Hot Fuel Gases

(76) Inventors: Manuela Serban, Glenview, IL (US); Alakananda Bhattacharyya, Glen Ellyn, IL (US); Lisa M. King, Lake in the Hills, IL (US)

Correspondence Address: HONEYWELL/UOP;PATENT SERVICES, 101 COLUMBIA DRIVE, P O BOX 2245 MAIL STOP AB/2B, MORRISTOWN, NJ, 07962, US

(21) Appl. No.: 12/492,495

(22) Filed: Jun. 26, 2009

(51) Int. Cl. C09K 3/00

(52) U.S. Cl. 252/182.33

(57) ABSTRACT

The present invention involves a process and materials for desulfurization of a gaseous stream comprising contacting the gas stream with a manganese aluminate catalyst. The manganese aluminate catalyst is preferably selected from the group consisting of Mn₂ₓAl₂O₂ₓ₊₃, Mn_{(2-y)}(MnO)_{y}Al₂O_{(5-y)}, Mn_{(4-y)}(MnO)_{y}Al₂O_{(7-y)}, Mn_{(6-y)}(MnO)_{y}Al₂O_{(9-y)}, Mn_{(1-z)}(MnO)_{z}AlO_{(3-z)} and intermediates thereof, wherein x≧0.5, 0≦y≦2 and 0≦z≦1. Preferably, x is between 1 and 3.

### BACKGROUND OF THE INVENTION

The present invention relates to processes and materials that are effective in the desulfurization of hot gases. In particular, the invention relates to the use of certain metal oxides in the desulfurization of hot fuel gases from integrated gasification combined cycle plants.

One of the directions being taken in the United States as well as a number of other countries such as China, to reduce energy dependence from natural gas and oil, is to turn to coal. A promising alternative to coal combustion is coal gasification. Integrated gasification combined cycle (IGCC) involves the use of one or more gas turbines, fired by coal-derived syngas together with downstream steam turbines that are driven by the waste heat produced from the gas turbines. There are currently five IGCC plants in operation while other planned plants have generally been cancelled or delayed due to increasing capital costs and the uncertainties regarding regulation of carbon dioxide emissions from such plants. However, due to the abundance of coal in the United States and certain other areas of the world and its lower cost when compared to most of the alternative sources of energy, it is likely that coal will continue to be used to produce electricity in existing plants as well as the additional plants that will be needed to meet future demand. Current IGCC plants cost about 10-20% more than conventional coal combustion power plants. However, these cost comparisons are for plants without carbon capture and sequestration capabilities.

Efforts to develop the next generation IGCC plants are continuing due to the belief that the IGCC approach is potentially the cleanest way to generate electricity from coal or petroleum coke, and more amenable to carbon dioxide capture and sequestration than coal combustion plants. It is estimated that an IGCC plant can capture and compress carbon dioxide at about one-half the incremental cost of a conventional pulverized coal fired power plant. This cost savings is due to the clean-up of IGCC coal-derived syngas being done before it is used to fire the gas turbines when it has a much smaller net volume than the flue gas produced from coal-fired power plants. The coal-fired power plants routinely employ larger, more energy intensive equipment.

A major component of any IGCC plant is the coal gasification system that converts pulverized coal into synthetic gas (syngas) or fuel gas. The fuel gas comprises carbon monoxide, hydrogen and often carbon dioxide as well as various impurities. Among these impurities are sulfur compounds such as COS and H₂S which need to be removed from the fuel gas before the purified fuel gas is sent to the gas turbine. The prior art methods of removing the sulfur compounds include wet scrubbing techniques using either chemical or physical solvents. If the fuel gas is cleaned with conventional cold gas cleanup, the penalties in both thermal and overall process efficiencies will be larger for air-blown gasifiers compared to oxygen blown gasifiers because the air-blown gasifiers produce twice the volume of fuel gas produced by oxygen blown gasifiers. However, both types of gasifiers would benefit by the successful development of hot gas cleanup techniques. In current systems, the hot fuel gas is cooled from about 1050° to about 1250° C. for a fluidized or entrained bed, respectively to about 40° C. in order to remove the sulfur compounds. Then the desulfurized fuel gas is heated back up to be sent through a combustor and then to a gas turbine. There are significant energy savings if it were possible to remove the sulfur compounds at the highest inlet temperature at which the gas turbine fuel control and delivery systems can be designed to operate. Hot gas cleanup would also avoid many of the operational complexities, space requirements and capital costs associated with cool down, reheating systems or heat exchange systems. Other reasons for hot gas clean up in IGCC plants include avoiding the production of sour water which is produced if the fuel gas is cooled below the dew point of water and consequently avoiding the need for treating the sour water and avoiding the production of “black-mud” (a mixture of water, char and ash) produced in water quenching or water scrubbing of particulates from fuel gas. Also, if the particulates are removed when dry, through a dry filtration system, these particulates could be recycled to the gasifier to improve fuel utilization and process efficiency.

Coal-derived fuel gases used for power generation or cogeneration need to be substantially cleaned before being burned in a gas turbine or used for chemical synthesis, in reactions such as production of methanol, ammonia or urea or in Fischer-Tropsch synthesis. Cleanup techniques require removal of solid particulates, sulfur-containing gases including H₂S and COS and removal of trace contaminants resulting from the gasification of coal including NH₃, HCN, chlorides, alkali metals, metal carbonyls, mercury, arsenic and selenium. The successful development of hot-gas cleanup techniques depends on the ability to remove all of these impurities at high temperatures. The present invention provides a class of highly stable, highly active and regenerable materials for removing sulfur from coal-derived fuel gases at elevated temperatures.

The sulfidation reaction of a large number of metal oxides such as oxides of zinc, iron, cerium, copper, calcium, molybdenum, manganese and mixed metal oxides has favorable thermodynamics over a broad temperature range. However, none of these bulk metal oxides fulfill the requirements of a potential commercial fuel gas desulfurization sorbent. Even though the intrinsic kinetics for most of the metal oxides are rapid, the overall rate is slow because of the lack of surface area and the formation of the metal sulfide layer on the metal oxide surface which acts as a diffusion barrier against rapid and complete sulfidation. Also, all metal oxides have relatively poor attrition resistance, making them inappropriate candidate materials for fluidized bed or transport reactors. Metal or mixed metal aluminate spinels with increasingly higher metal contents in the spinel structure have been found to be regenerable materials with high activity and capacity for sulfur removal from coal derived fuel gases at temperatures above 700° C. Metal oxide spinel structures used for the desulfurization of coal-derived fuel gases have been reported before. However, the compositions and preparation method employed in the present invention are novel and yield much improved catalysts. In addition, materials with very high active metal oxide content in the spinel structure (O>4) have not been reported before for this application. In the present invention we disclose heat treated compositions and their mixed hydroxide precursors for effective sulfidation and sulfur release cycles.

At temperatures greater than about 700° C., the sulfidation reaction for manganese oxides is favorable both thermodynamically and kinetically. The synthesis of the spinel-like structures used in this study followed a procedure for what are known as MOSS (Metal Oxide Solid Solution) materials. The first step in the synthesis process is to prepare a layered double hydroxide via a ‘soft’ hydrothermal synthesis. Layered double hydroxides (LDH) consist of stacked hydroxyl layers or sheets composed of edge-sharing octahedra and an interlamellar space separating the layers. If the layer does not contain a trivalent metal cation or other cation of greater oxidation state, then the layer is neutral. LDH's are clays with charged layers. The charge is generated via the substitution of a divalent metal cation by a more highly charged, usually a trivalent, metal cation. Each substitution by a trivalent cation translates into a net gain of a positive charge for the layer. This layer charge is counterbalanced by anions in the interlayer spaces.

LDH's are termed anionic clays because anions, as well as water, occupy the interlayer spaces. The more familiar zeolitic, molecular sieve and clay (Smectite clays) materials are known as cationic because cations occupy their cavities or interlayer spaces. The cations within these structures can be exchanged with protons to create Bronsted acid sites. Similarly, anions are exchanged out of the LDH framework and are replaced by hydroxyls. These hydroxyls are a good leaving group that functions as a base site.

Few LDH's exist in nature, but they are easily synthesized and are relatively inexpensive to prepare in the laboratory. LDH's include a wide variety of compositions. The general formula for this material is:

[M₍₁₋ₓ₎²⁺Mₓ³⁺(OH)₂]^{x+}(A_{x/n}ⁿ⁻)*mH₂O

where 0.1≦x≦0.5, n is an integer in the range 1≦n≦6, m is zero or a positive number, where octahedral sites M²⁺ are Mg, Ni, Mn, Zn, Co, Fe, Cu and M³⁺ are Al, Fe or Cr. Mani, K. N., U.S. Pat. No. 6,017,433.

The counterbalancing anions A are CO₃²⁻, SO₄²⁻, NO₃⁻, Cl⁻, Br⁻, ClO₄⁻, I⁻, F⁻, and OH⁻. A specific LDH mineral with the composition of Mg₆Al₂(OH)₁₆CO₃*4H₂O is called hydrotalcite. Other examples of naturally occurring minerals are Takovite, Ni₆Al₂(OH)₁₆(CO₃)*4H₂O and Pyroaurite, Mg₆Fe₂(OH)₁₆(CO₃)*H₂O. Two different synthesis routes for LDH's are described in the literature. The preferred synthesis procedure is the Feitknecht synthesis (J. J. Alcaraz et al., Catalysis Today 43 (1998) 89-99) because it produces samples with the most desirable properties: small crystals, high surface areas and the highest activity. The LDH is the precursor to the basic material and the LDH is prepared in a preferred embodiment in which Mn acetate and Al nitrate salts are dissolved in H₂O and slowly added to an aqueous solution of NaOH and NaCO₃ with vigorous stirring. A pH adjustment is made and the reaction mixture is then heated at about 80° C. for 16-20 hours with stirring. The resultant LDH solids are recovered and washed by vacuum filtration. The LDH materials have the Brucite structure with layers of M2+ and M3+ oxide sheets separated by anions (CO₃²⁻, in this case). In the second prep step, these LDH materials are then calcined (>450° C.) wherein the surface area and basicity increase significantly yielding very basic metal oxide solid solutions, known as MOSS materials. The LDH has a lower surface area (about 50-100 m²/g) compared to MOSS materials. The transformation to MOSS, involves the decomposition of the LDH structure due to the loss of the interlayer anions and skeletal hydroxyls. The layers delaminate, meaning that they collapse on each other and break apart into small individual aggregates. This increases the surface area above 150 m²/g. Calcinations were preferably between 400° and 800° C. The preferred temperatures produce a high density spinel. The resultant MOSS materials (LDH materials after calcination at 800° C. in air) yield final compositions that correspond to at least one of the general compositions described in Table 1. In the present invention, at least one of the MOSS materials used contains Mn.

TABLE 1

Mn₍₁₋ₓ₎MₓAl_{(2-y)}M′_{y}O₄ where 0 ≦ x ≦ 0.75 and 0 ≦ y ≦ 1.5
M = divalent metal(s); M′ = trivalent metal(s)
Mn₍₂₋ₓ₎MₓAl_{(2-y)}M′_{y}O₅ where 0 ≦ x ≦ 0.75 and 0 ≦ y ≦ 1.5
M = divalent metal(s); M′ = trivalent metal(s)
Mn₍₄₋ₓ₎MₓAl_{(2-y)}M′_{y}O₇ where 0 ≦ x ≦ 3.5 and 0 ≦ y ≦ 1.5
M = divalent metal(s); M′ = trivalent metal(s)

These 800° C. calcined materials are thought to be spinel-like structure(s) as observed by XRD with a variety of Mn oxides present as well. Higher Mn levels yield spinel-like materials with increasing levels and variety of Mn oxides. The present invention uses a manganese-containing compound comprising manganese, aluminum and oxygen having a general formula Mn₂ₓAl₂O₂ₓ₊₃, wherein 0.5≦x≦3. Preferably, Mn, is present therein as MnO, at a mass fraction between about 5 and 25% of said Mn. In addition, Mn, is present as a manganese aluminate solid solution in this general formula Mn₂ₓAl₂O₂ₓ₊₃ at a mass fraction between about 75 and 95% of said Mn.

The manganese-containing compound shows characteristic lines at 18.022±0.5 deg. 2-theta, 20.212±0.5 deg. 2-theta, 21.551±0.5 deg. 2-theta, 23.138±0.5 deg. 2-theta, 29.018±0.5 deg. 2-theta, 31.041±0.5 deg. 2-theta, 32.521±0.5 deg. 2-theta, 32.959±0.5 deg. 2-theta, 36.139±0.5 deg. 2-theta, 36.358±0.5 deg. 2-theta, 38.260±0.5 deg. 2-theta, 38.354±0.5 deg. 2-theta, 43.715±0.5 deg. 2-theta, 45.178±0.5 deg. 2-theta, 51.216±0.5 deg. 2-theta, 52.552±0.5 deg. 2-theta, 54.000±0.5 deg. 2-theta, 55.163±0.5 deg. 2-theta, 56.783±0.5 deg. 2-theta, 58.581±0.5 deg. 2-theta, 60.081±0.5 deg. 2-theta, 64.162±0.5 deg. 2-theta, 64.639±0.5 deg. 2-theta, and 65.744±0.5 deg. 2-theta, under X-Ray Diffraction.

In another embodiment of the invention, the manganese-containing compound shows a majority of the characteristic lines at 18.022±0.5 deg. 2-theta, 20.212±0.5 deg. 2-theta, 21.551±0.5 deg. 2-theta, 23.138±0.5 deg. 2-theta, 29.018±0.5 deg. 2-theta, 31.041±0.5 deg. 2-theta, 32.521±0.5 deg. 2-theta, 32.959±0.5 deg. 2-theta, 36.139±0.5 deg. 2-theta, 36.358±0.5 deg. 2-theta, 38.260±0.5 deg. 2-theta, 38.354±0.5 deg. 2-theta, 43.715±0.5 deg. 2-theta, 45.178±0.5 deg. 2-theta, 51.216±0.5 deg. 2-theta, 52.552±0.5 deg. 2-theta, 54.000±0.5 deg. 2-theta, 55.163±0.5 deg. 2-theta, 56.783±0.5 deg. 2-theta, 58.581±0.5 deg. 2-theta, 60.081±0.5 deg. 2-theta, 64.162±0.5 deg. 2-theta, 64.639±0.5 deg. 2-theta, and 65.744±0.5 deg. 2-theta, under X-Ray Diffraction.

More specifically, the manganese-containing compound is selected from the group consisting of Mn₂ₓAl₂O₂ₓ₊₃, Mn_{(2-y)}(MnO)_{y}Al₂O_{(5-y)}, Mn_{(4-y)}(MnO)_{y}Al₂O_{(7-y)}, Mn_{(6-y)}(MnO)_{y}Al₂O_{(9-y)}, Mn_{(1-z)}(MnO)_{z}AlO_{(3-z)} and intermediates thereof, wherein x≧0.5, 0≦y≦2 and 0≦z≦1.

In another embodiment of the invention, the manganese-containing compound shows characteristic lines at 18.235±0.5 deg. 2-theta, 29.542±0.5 deg. 2-theta, 30.980±0.5 deg. 2-theta, 31.719±0.5 deg. 2-theta, 33.240±0.5 deg. 2-theta, 36.480±0.5 deg. 2-theta, 39.182±0.5 deg. 2-theta, 44.623±0.5 deg. 2-theta, 48.735±0.5 deg. 2-theta, 52.347±0.5 deg. 2-theta, 55.018±0.5 deg. 2-theta, 56.625±0.5 deg. 2-theta, 58.919±0.5 deg. 2-theta, 61.158±0.5 deg. 2-theta, and 64.561±0.5 deg. 2-theta, under X-Ray Diffraction.

In another embodiment of the invention, the manganese-containing compound shows a majority of the characteristic lines at 18.235±0.5 deg. 2-theta, 29.542±0.5 deg. 2-theta, 30.980±0.5 deg. 2-theta, 31.719±0.5 deg. 2-theta, 33.240±0.5 deg. 2-theta, 36.480±0.5 deg. 2-theta, 39.182±0.5 deg. 2-theta, 44.623±0.5 deg. 2-theta, 48.735±0.5 deg. 2-theta, 52.347±0.5 deg. 2-theta, 55.018±0.5 deg. 2-theta, 56.625±0.5 deg. 2-theta, 58.919±0.5 deg. 2-theta, 61.158±0.5 deg. 2-theta, and 64.561±0.5 deg. 2-theta, under X-Ray Diffraction.

More specifically, the manganese-containing compound is selected from the group consisting of Mn₍₁₋ₓ₎MₓAl_{(2-y)}M′_{y}O₄ or Mn₍₂₋ₓ₎MₓAl_{(2-y)}M′_{y}O₅, where 0≦x≦0.75 and 0≦y≦1.5 or Mn₍₄₋ₓ₎MₓAl_{(2-y)}M′_{y}O₇ where 0≦x≦3.5 and 0≦y≦1.5. Where M is a divalent metal and M′ is a trivalent metal.

In another embodiment, the invention involves a process of making a manganese-containing compound comprising manganese, aluminum and oxygen having a general formula Mn₂ₓAl₂ₓ₊₃, wherein 0.5≦x≦3. The process comprises mixing an aqueous solution of metal salts with a caustic solution to produce a mixture having a pH between about 8 and 12; hydrothermally treating the mixture at a temperature between about 60° and 100° C.; isolating solids from the mixture by vacuum filtration and then washing said solids; drying the solids at a temperature from about ambient to 100° C. to produce dried isolated solids; subjecting the dried isolated solids to a heat treatment at about 600° to 800° C.; and then activating the heat treated dried isolated solids. Preferably the aqueous solution of metal salts and said caustic solution are mixed for about 1 to 2 hours. The mixture is preferably hydrothermally treated for about 15 to 20 hours. The activation of the heat treated material is at a temperature from about 250° to 850° C. and at a pressure from about 10 to 80 bar for about 0.25 to 4 hours. The activation may be under a gaseous stream comprising H₂S, H₂, CO and CO₂. The heat treatment is for a period of from about 4 to 8 hours. The isolated solids are dried for a period of from 1 to 24 hours. The aqueous solution of metal salts contains metal salts that are selected from the group consisting of manganese acetates, aluminum acetates, manganese chlorides, aluminum chlorides, manganese sulfates, aluminum sulfates, manganese nitrates and aluminum nitrates and mixtures thereof. Preferably the metal salts comprise manganese nitrates or aluminum nitrates and mixtures thereof.

In yet another embodiment of the invention, the invention involves a process for removal of sulfur from a gaseous stream, comprising contacting said stream with a manganese-containing compound. A typical gaseous stream comprises carbon monoxide, carbon dioxide, hydrogen, and sulfur compounds. The gaseous stream may comprise a fuel gas or a synthesis gas comprising hydrogen, carbon monoxide, sulfur-containing compounds and impurities. The manganese-containing compound is selected from the group consisting of Mn₂ₓAl₂O₂ₓ₊₃, Mn_{(2-y)}(MnO)_{y}Al₂O_{(5-y)}, Mn_{(4-y)}(MnO)_{y}Al₂O_{(7-y)}, Mn_{(6-y)}(MnO)_{y}Al₂O_{(9-y)}, Mn_{(1-z)}(MnO)_{z}AlO_{(3-z)} and intermediates thereof, wherein x≧0.5, 0≦y≦2 and 0≦z≦1. Preferably x is between 1 and 3 (1≦x≦3). In this invention, this manganese contained compound reacts with more than 10% of sulfur compounds within the gaseous stream and preferably with more than 50% of sulfur compounds within the gaseous stream. The manganese-containing compounds contacts the gaseous stream at a temperature from about 250° to 850° C. and preferably at a temperature from about 700° to 850° C. The pressure is typically from about 10 bar to 80 bar and the GHSV (at STP) is higher than 500 m³/m³/hr.

The preferred materials are prepared from a combination of metals. Preferably the ratio of Mn/Al is from about 1.0 to 3.0, but may be as high as 4.

### EXAMPLE 1

### Preparation of Mn/Al=2.3 (Mn_{4.58}Al₂O_{7.58}*0.39H₂O)

A Layered Double Hydroxide (LDH) precursor was made by dissolving 7.95 g NaCO₃*H₂O in 400 ml de-ionized H₂O. While stirring, 24.0 g NaOH was added. The resultant clear solution was allowed to cool to room temp. A premixed solution of 36.8 g Mn(OAc)₂*4H₂O and 28.1 g Al(NO₃)₃*9H₂O dissolved in 375 ml de-ionized H₂O, was then added drop-wise while stirring. This addition took 2 hours. The pH of the resultant reaction mixture was adjusted to 10.14 with a 50% aqueous HNO₃ solution and allowed to stir vigorously for 1 hour. The reaction mixture was then transferred to a 1 L glass flask equipped with stirring, a condenser and temperature monitoring. The mixture was heated to 84° C. and held at temperature for 16 hours with vigorous stirring throughout.

The solids were then recovered by vacuum filtration, washed well (12 L) with de-ionized H₂O and allowed to dry in ambient air.

The recovered solids (16.1 g) were identified by XRD as having a layered double hydroxide like structure. A portion of these solids (6.5 g) were calcined in flowing air. The material was heated to 600° C. at 3° C./min, held at 600° C. for 8 hours then cooled to room temperature at 10° C./min. ICP analysis of the calcined metal oxide solid solution (MOSS) showed Al=11.6% (volatile free), Mn=54.2% (volatile free) with LOI (loss of ignition) at 900° C.=5.97 mass %, giving a product formula of: Mn_{4.58}Al₂O_{7.58}*0.39H₂O. N₂ BET surface area was measured at 85 m²/g with a pore volume of 0.137 cc/g and a pore diameter of 64 Å.

### EXAMPLE 2

### Preparation of (Mn+Zn)/Al=2.24

A Layered Double Hydroxide (LDH) precursor was made by dissolving 7.95 g NaCO₃:H₂O in 400 ml de-ionized H₂O. While stirring, 24.0 g NaOH was added. The resultant clear solution was allowed to cool to room temp. A premixed solution of 18.38 g Mn(OAc)₂*4H₂O, 22.3 g Zn(NO₃)₂*6H₂O and 28.14 g Al(NO₃)₃*9H₂O dissolved in 375 ml de-ionized H₂O, was then added drop wise while stirring. This addition took 2 hours. The reaction mixture was then transferred to a 1 L glass flask equipped with stirring, a condenser and temperature monitoring. The mixture was heated to 75° C. and held at temperature for 16 hours with vigorous stirring throughout. The solids were then recovered by vacuum filtration, washed well (12 L) with de-ionized H₂O and allowed to dry in ambient air.

The recovered solids (15.06 g) were identified by XRD as having a layered double hydroxide like structure. A portion of these solids (7.05 g) were calcined in flowing air. The material was heated to 600° C. at 3° C./min, held at 600° C. for 8 hours then cooled to room temperature at 10° C./min.

A portion of the 600° C. calcined solids (3.1 g) were further calcined in flowing air. The material was heated to 800° C. at 3° C./min, held at 800° C. for 8 hours, then cooled to room temperature at 10° C./min (33416-49L).

ICP analysis of the 800° C. calcined metal oxide solid solution (MOSS) showed Al=11.7% (volatile free), Mn=27.6% (volatile free), Zn=30.6% with LOI (loss of ignition) at 900° C.=2.30 mass %, giving a product formula of Mn_{0.58}Zn_{0.54}Al₂O_{4.16}*0.23H₂O.

### EXAMPLE 3

Three solid solution spinels, Mn/Al=0.27 (Mn_{0.54}Al₂O_{3.54}*0.17H₂O), Mn/Al=1 (Mn₂Al₂O₅*0.07H₂O) and Mn/Al=2.3 (Mn_{4.58}Al₂O_{7.58}*0.39H₂O) were sulfided at 750° C., atmospheric pressure, 1600 h⁻¹ space velocity with a feed gas consisting of 1.35% H₂S+13.3% H₂+13.14% CO+13.5% CO₂+59% N₂. The regeneration was performed in-situ with lean air (2% O₂ in N₂) at 800° C. and approximately 1600 h⁻¹ space velocity. The solid solution spinel with high active metal oxide content in the spinel structure, i.e., Mn/Al=2.3 performed incomparably better than the analog materials with lower Mn content, i.e., Mn/Al=0.27 and Mn/Al=1. The Mn/Al=2.3 solid solution spinel can easily be cycled between the oxide and sulfide phases. With this particular space velocity (1600 h⁻¹) the sample was sulfided to 90% of the maximum theoretical loading in 10 hours and was fully regenerated in 5 hours with SO₂ being the only off-gas produced. Most importantly, the pre-breakthrough was reached only after approximately 300 minutes on stream with no H₂S detected in the exhaust stream and with 14 wt-% S uptake (52% of the maximum theoretical loading) up to that particular point. In the second sulfidation cycle, after the in-situ oxidative regeneration, the material performed identically, with the pre-breakthrough reached after approximately 300 minutes on stream. The x-ray diffraction spectra of the sulfided Mn/Al=2.3 spinel that was sulfided twice suggests that the structure remains intact after the two-cycles test.

TABLE 2

| Mn/Al | | Mn | wt-% S uptake before |
|---|---|---|---|
| ratio | Mn Spinel Composition | (wt. %) | sulfur breakthrough |
| 0.27 | Mn_{0.54}Al₂O_{3.54} * 0.17H₂O | 20.2 | 0 |
| 1 | Mn₂Al₂O₅ * 0.07H₂O | 41.8 | 7.6 |
| 2.3 | Mn_{4.58}Al₂O_{7.58} * 0.39H₂O | 54.8 | 14.2 |

### EXAMPLE 4

Several mixed metal solid solution spinels with the final composition Mn+Me/Al˜2 (where Me=Mg, Cu, Co, or Zn) were prepared and tested at 750° C., atmospheric pressure, 1600 h⁻¹ space velocity with a feed gas consisting of 1.35% H₂S+13.3% H₂+13.14% CO+13.5% CO₂+59% N₂. None of these materials performed better than the Mn/Al=2.3 solid solution spinel. The pre-breakthrough time for all the above materials was below that of the Mn/Al=2.3 solid solution spinel. Also, the XRD analysis of the spent Cu+Mn/Al=2 mixed spinel material indicates that the spinel structure collapsed during the 6 hours testing at 750° C. The Mn+Zn/Al˜2 solid solution spinel performed very well in one sulfidation cycle, with more than 200 minutes on stream with no H₂S detected in the exhaust, however the ICP analysis suggested that after the 5.5 hours at 750° C., approximately 6 wt-% Zn is lost from the solid solution spinel. The material that was tested was not stable for high temperature desulfurization.

TABLE 3

| | Mn | Metal | wt. % S uptake before |
|---|---|---|---|
| (Mn + Metal)/Al ratio | (wt. %) | (wt %) | sulfur breakthrough |
| (Mn + Cu)/Al = 2.13 | 27.6 | 30.4% Cu | 6.8 |
| (Mn + Zn)/Al = 0.33 | 10.4 | 15.5% Zn | 0 |
| (Mn + Zn)/Al = 2.24 | 27.6 | 30.6% Zn | 13 |
| (Mn + Mg)/Al = 2.11 | 34.5 | 13.2% Mg | 6.4 |
| (Mn + Co)/Al = 2.13 | 28.6 | 27.5% Co | 1.6 |

From the foregoing, it will be appreciated that although specific examples have been described herein for purposes of illustration, various modifications may be made without deviating from the spirit or scope of this disclosure. It is therefore intended that the foregoing detailed description be regarded as illustrative rather than limiting, and that it be understood that it is the following claims, including all equivalents, that are intended to particularly point out and distinctly claim the claimed subject matter.

1. A manganese-containing compound comprising manganese, aluminum and oxygen having a general formula Mn₂ₓAl₂O₂ₓ₊₃, wherein 0.5≦x≦3.

2. The manganese-containing compound of claim 1 wherein Mn, present therein as MnO, is present at a mass fraction between about 5 and 25% of said Mn.

3. The manganese-containing compound of claim 1 wherein Mn, is present as a manganese aluminate solid solution in said general formula Mn₂ₓAl₂O₂ₓ₊₃ at a mass fraction between about 75 and 95% of said Mn.

4. The manganese-containing compound of claim 1 wherein said manganese-containing compound shows characteristic lines at 18.022±0.5 deg. 2-theta, 20.212±0.5 deg. 2-theta, 21.551±0.5 deg. 2-theta, 23.138±0.5 deg. 2-theta, 29.018±0.5 deg. 2-theta, 31.041±0.5 deg. 2-theta, 32.521±0.5 deg. 2-theta, 32.959±0.5 deg. 2-theta, 36.139±0.5 deg. 2-theta, 36.358±0.5 deg. 2-theta, 38.260±0.5 deg. 2-theta, 38.354±0.5 deg. 2-theta, 43.715±0.5 deg. 2-theta, 45.178±0.5 deg. 2-theta, 51.216±0.5 deg. 2-theta, 52.552±0.5 deg. 2-theta, 54.000±0.5 deg. 2-theta, 55.163±0.5 deg. 2-theta, 56.783±0.5 deg. 2-theta, 58.581±0.5 deg. 2-theta, 60.081±0.5 deg. 2-theta, 64.162±0.5 deg. 2-theta, 64.639±0.5 deg. 2-theta, and 65.744±0.5 deg. 2-theta, under X-Ray Diffraction.

5. The manganese-containing compound of claim 1 wherein said manganese-containing compound shows a majority of the characteristic lines at 18.022±0.5 deg. 2-theta, 20.212±0.5 deg. 2-theta, 21.551±0.5 deg. 2-theta, 23.138±0.5 deg. 2-theta, 29.018±0.5 deg. 2-theta, 31.041±0.5 deg. 2-theta, 32.521±0.5 deg. 2-theta, 32.959±0.5 deg. 2-theta, 36.139±0.5 deg. 2-theta, 36.358±0.5 deg. 2-theta, 38.260±0.5 deg. 2-theta, 38.354±0.5 deg. 2-theta, 43.715±0.5 deg. 2-theta, 45.178±0.5 deg. 2-theta, 51.216±0.5 deg. 2-theta, 52.552±0.5 deg. 2-theta, 54.000±0.5 deg. 2-theta, 55.163±0.5 deg. 2-theta, 56.783±0.5 deg. 2-theta, 58.581±0.5 deg. 2-theta, 60.081±0.5 deg. 2-theta, 64.162±0.5 deg. 2-theta, 64.639±0.5 deg. 2-theta, and 65.744±0.5 deg. 2-theta, under X-Ray Diffraction.

6. The manganese-containing compound of claim 1 wherein said manganese-containing compound is selected from the group consisting of Mn₂ₓAl₂O₂ₓ₊₃, Mn_{(2-y)}(MnO)_{y}Al₂O_{(5-y)}, Mn_{(4-y)}(MO)_{y}Al₂O_{(7-y)}, Mn_{(6-y)}(MnO)_{z}Al₂O_{(9-y)}, Mn_{(1-z)}(MnO)_{z}AlO_{(3-z)} and intermediates thereof, wherein x≧0.5, 0y≦y≦2 and 0≦z≦1.

7. The manganese-containing compound of claim 6 wherein 1≦x≦3.

8. The manganese-containing compound of claim 1 wherein said compound contains additional divalent metal M or trivalent metal M′ with the general formula Mn₍₁₋ₓ₎MₓAl_{(2-y)}M′_{y}O₄ or Mn₍₂₋ₓ₎MₓAl_{(2-y)}M′_{y}O₅, where 0≦x≦0.75 and 0≦y≦1.5 or Mn₍₄₋ₓ₎MₓAl_{(2-y)}M′_{y}O₇ where 0≦x≦3.5 and 0≦y≦1.5.

9. The manganese-containing compound of claim 8 wherein said additional divalent metal M or trivalent metal M′ in said manganese-containing compound shows characteristic lines at, 18.235±0.5 deg. 2-theta, 29.542±0.5 deg. 2-theta, 30.980±0.5 deg. 2-theta, 31.719±0.5 deg. 2-theta, 33.240±0.5 deg. 2-theta, 36.480±0.5 deg. 2-theta, 39.182±0.5 deg. 2-theta, 44.623±0.5 deg. 2-theta, 48.735±0.5 deg. 2-theta, 52.347±0.5 deg. 2-theta, 55.018±0.5 deg. 2-theta, 56.625±0.5 deg. 2-theta, 58.919±0.5 deg. 2-theta, 61.158±0.5 deg. 2-theta, and 64.561±0.5 deg. 2-theta, under X-Ray Diffraction.

10. The manganese-containing compound of claim 8 wherein said manganese-containing compound shows a majority of the characteristic lines at, 18.235±0.5 deg. 2-theta, 29.542±0.5 deg. 2-theta, 30.980±0.5 deg. 2-theta, 31.719±0.5 deg. 2-theta, 33.240±0.5 deg. 2-theta, 36.480±0.5 deg. 2-theta, 39.182±0.5 deg. 2-theta, 44.623±0.5 deg. 2-theta, 48.735±0.5 deg. 2-theta, 52.347±0.5 deg. 2-theta, 55.018±0.5 deg. 2-theta, 56.625±0.5 deg. 2-theta, 58.919±0.5 deg. 2-theta, 61.158±0.5 deg. 2-theta, and 64.561±0.5 deg. 2-theta, under X-Ray Diffraction.

11. A process of making a manganese-containing compound comprising manganese, aluminum and oxygen having a general formula Mn₂ₓAl₂O₂ₓ₊₃, wherein 0.5≦x≦3, said process comprising:
a) mixing an aqueous solution of metal salts with a caustic solution to produce a mixture having a pH between about 8 and 12;
b) hydrothermally treating said mixture at a temperature between about 60° and 100° C.;
c) isolating solids from said mixture by vacuum filtration and then washing said solids;
d) drying said solids at a temperature from about ambient to 100° C. to produce dried isolated solids;
e) subjecting said dried isolated solids to a heat treatment at about 600° to 800° C.; and
f) then activating said heat treated dried isolated solids.

12. The process of claim 11 wherein said aqueous solution of metal salts and said caustic solution are mixed for about 1 to 2 hours.

13. The process of claim 11 wherein said mixture is hydrothermally treated for about 15 to 20 hours.

14. The process of claim 11 wherein said heat treatment is for a period of from about 4 to 8 hours.

15. The process of claim 11 wherein said isolated solids are dried for a period of from 1 to 24 hours.

16. The process of claim 11 wherein said activation of said heat treated material is at a temperature from about 250° to 850° C. and at a pressure from about 10 to 80 bar for about 0.25 to 4 hours.

17. The process of claim 11 wherein said activation is under a gaseous stream comprising H₂S, H₂, CO and CO₂.

18. The process of claim 11 wherein said activation is under a gaseous stream comprising H₂S, H₂, CO, CO₂ and H2O.

19. The process of claim 11 wherein said metal salts are selected from the group consisting of manganese acetates, aluminum acetates, manganese chlorides, aluminum chlorides, manganese sulfates, aluminum sulfates, manganese nitrates and aluminum nitrates and mixtures thereof.

20. The process of claim 11 wherein said metal salts are selected from the group consisting of manganese nitrates and aluminum nitrates and mixtures thereof.
